(19) United States
(12) Patent Application Publication
(10) Pub. No.: US 2026/0225045 A1
(43) Pub. Date: Aug. 6, 2026

(54) COMPOSITE SEMIPERMEABLE MEMBRANE, COMPOSITE SEMIPERMEABLE MEMBRANE MODULE, FLUID SEPARATION DEVICE, AND METHOD FOR PRODUCING COMPOSITE SEMIPERMEABLE MEMBRANE

(71) Applicant: TORAY INDUSTRIES, INC., Tokyo (JP)

(72) Inventors: Shunsuke MIZUNO, Shiga (JP); Takaaki YASUDA, Shiga (JP); Hiroki MINEHARA, Shiga (JP); Takafumi OGAWA, Shiga (JP); Atsushi OGAWA, Shiga (JP)

(73) Assignee: TORAY INDUSTRIES, INC., Tokyo (JP)

(21) Appl. No.: 19/152,120

(22) PCT Filed: Feb. 1, 2024
(86) PCT No.: PCT/JP2024/003268

§ 371 Date: Jul. 30, 2025

(30) Foreign Application Priority Data
Feb. 3, 2023 (JP) 2023-015302
Feb. 3, 2023 (JP) 2023-015303
Feb. 3, 2023 (JP) 2023-015304

(51) Int. Cl. B01D 69/12; B01D 71/38; B01D 71/56

(52) U.S. Cl. CPC B01D 69/1216; B01D 69/1251; B01D 71/381; B01D 71/56; B01D 2323/30; B01D 2325/04

(57) ABSTRACT

Provided is a composite semipermeable membrane including: a support membrane; a separation functional layer disposed on the support membrane and containing a crosslinked polyamide; and a coating layer disposed on the separation functional layer and containing a vinyl alcohol copolymer having a structure represented by the general formula (1), provided that in the general formula (1), X is a divalent hydrocarbon group having 2 to 6 carbon atoms, and l, m and n are the number of repeating units.

### TECHNICAL FIELD

The present invention relates to a composite semipermeable membrane, a composite semipermeable membrane module, a fluid separation device, and a method for producing a composite semipermeable membrane that are useful for selective separation of a liquid mixture.

### BACKGROUND ART

There are various techniques for removing substances (for example, salts) dissolved in a solvent (for example, water), and in recent years, membrane separation methods using a semipermeable membrane such as a reverse osmosis membrane or a nanofiltration membrane have been widely used as processes for energy saving and resource saving.

As a currently commercially available reverse osmosis membrane and nanofiltration membrane, a composite semipermeable membrane having a support membrane and a separation functional layer laminated on the support membrane is generally used. As a separation functional layer, a crosslinked polyamide obtained by a polycondensation reaction between a polyfunctional amine and a polyfunctional acid halide is known.

One of problems in membrane separation is a fouling phenomenon. The fouling phenomenon is a phenomenon in which a substance contained in water to be treated is adsorbed on a surface or an inner hole of a semipermeable membrane to inhibit permeation of a solution, thereby reducing water permeability of the composite semipermeable membrane. The fouling phenomenon is classified according to a type of substance to be adsorbed, and includes chemical fouling by adsorption of an organic substance, biofouling by adsorption of a microorganism, and the like.

As a method for preventing these fouling phenomena, coating a surface of a semipermeable membrane with a hydrophilic substance is known. For example, Patent Literature 1 proposes a method of preventing fouling by introducing a hydrophilic polymer having an acidic group to the surface of a separation functional layer through an amide bond.

### CITATION LIST

### Patent Literature

### Patent Literature 1: WO 2015/046582

### SUMMARY OF INVENTION

### Technical Problem

In various water treatment facilities such as a desalination plant, pretreatment such as ultrafiltration may be performed before reverse osmosis filtration or nanofiltration. When an oxidizing agent or the like used for cleaning an ultrafiltration membrane or the like used for the pretreatment leaks and comes into contact with a reverse osmosis membrane or a nanofiltration membrane, these membranes may be oxidized and deteriorated. In addition, since the reverse osmosis membrane or the nanofiltration membrane is generally subjected to chemical cleaning with acid and alkali, it is important that these membranes have acid resistance and alkali resistance.

Therefore, an object of the present invention is to provide a composite semipermeable membrane having excellent fouling resistance and further having good oxidation resistance, acid resistance, and alkali resistance.

### Solution to Problem

In order to solve the above problems, the present invention provides the following composite semipermeable membrane, composite semipermeable membrane module, fluid separation device, and method for producing a composite semipermeable membrane.
[1]A composite semipermeable membrane including:
a support membrane;
a separation functional layer disposed on the support membrane and containing a crosslinked polyamide; and
a coating layer disposed on the separation functional layer and containing a vinyl alcohol copolymer having a structure represented by the following general formula (1).

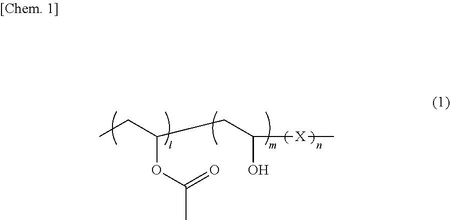

[Provided that in the general formula (1), X is a divalent hydrocarbon group having 2 to 6 carbon atoms, and l, m and n are the number of repeating units.]
[2] The composite semipermeable membrane according to [1], in which
X in the general formula (1) is a divalent hydrocarbon group having 2 carbon atoms.
[3] The composite semipermeable membrane according to [2], in which
X in the general formula (1) is an ethylene group.
[4] The composite semipermeable membrane according to any one of [1] to [3], in which
the vinyl alcohol copolymer has a copolymerization ratio n/(l+m+n) of 0.035 to 0.16.
[5] The composite semipermeable membrane according to any one of [1] to [4], in which
the vinyl alcohol copolymer has a degree of polymerization of 100 to 1,500.
[6] The composite semipermeable membrane according to any one of [1] to [5], in which
the vinyl alcohol copolymer has a degree of saponification of 96 mol % or more.
[7] The composite semipermeable membrane according to any one of [1] to [6], in which
a total thickness of the separation functional layer and the coating layer is 10 nm to 100 nm.
[8] The composite semipermeable membrane according to any one of [1] to [7], in which
the composite semipermeable membrane has a ratio of water permeability to helium permeability of 0.0105 to 0.0400.
[9] The composite semipermeable membrane according to any one of [1] to [8], in which
the composite semipermeable membrane has a He/O₂ selectivity of 7.5 to 10.4.
[10] The composite semipermeable membrane according to any one of [1] to [9], in which
an adhesive strength when the coating layers of the two composite semipermeable membranes are attached to each other is 0.9 N/25 mm to 5.0 N/25 mm.
[11]A composite semipermeable membrane module including the composite semipermeable membrane according to any one of [1] to [10].
[12]A fluid separation device including the composite semipermeable membrane module according to [11].
[13]A method for producing the composite semipermeable membrane according to any one of [1] to [10], the method including the following steps (i) and (ii):
(i) a step of subjecting a polyfunctional amine and a polyfunctional acid chloride to interfacial polymerization on a support membrane to form a separation functional layer containing a crosslinked polyamide; and
(ii) a step of forming a coating layer containing a vinyl alcohol copolymer represented by the following general formula (1), by bringing a solution containing the vinyl alcohol copolymer into contact with the separation functional layer and insolubilizing the vinyl alcohol copolymer.

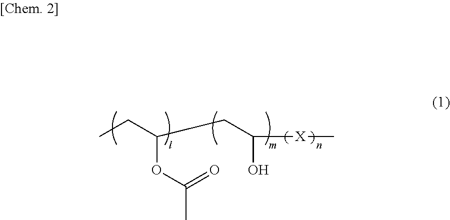

[Provided that in the general formula (1), X is a divalent hydrocarbon group having 2 to 6 carbon atoms, and l, m and n are the number of repeating units.]

### Advantageous Effects of Invention

According to the present invention, it is possible to provide a composite semipermeable membrane having excellent fouling resistance and further having good oxidation resistance, acid resistance, and alkali resistance.

### BRIEF DESCRIPTION OF DRAWINGS

FIG. 1 is a schematic view showing a cross-sectional structure of a composite semipermeable membrane.

FIG. 2 is a schematic view showing a structure of a composite semipermeable membrane including a separation functional layer and a coating layer having a pleated shape, in which (a) is a partially enlarged view and (b) is an enlarged view of Y in (a).

### DESCRIPTION OF EMBODIMENTS

Hereinafter, embodiments of the present invention will be described in detail, but the present invention is not limited in any way by these embodiments.

In the present description, “mass” is synonymous with “weight”.

### 1. Composite Semipermeable Membrane

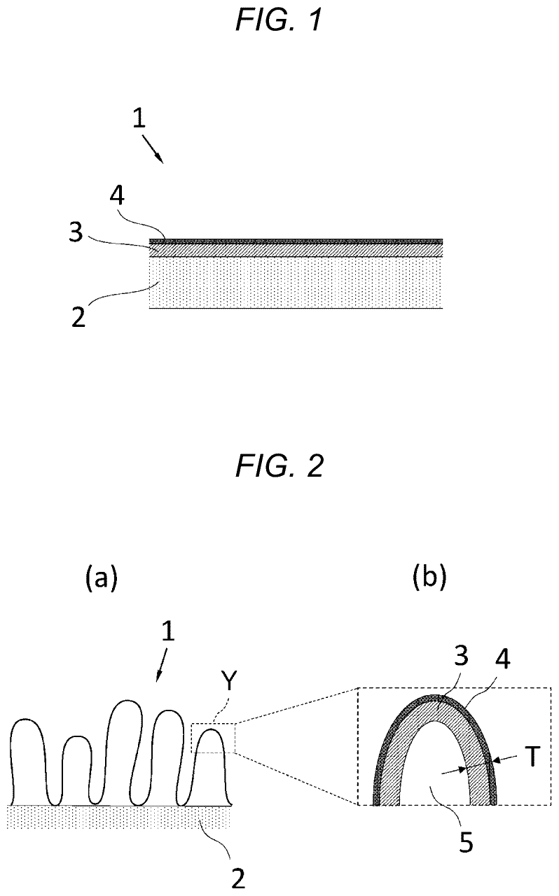

FIG. 1 shows a first mode of a structure of a composite semipermeable membrane 1 according to the present embodiment. The composite semipermeable membrane 1 of the present invention includes a support membrane 2, a separation functional layer 3, and a coating layer 4.

### (1-1) Support Membrane

The support membrane included in the composite semipermeable membrane according to the present embodiment has at least a porous support layer. The support membrane is for imparting strength to the composite semipermeable membrane, and the support membrane itself does not substantially have a solute separation performance.

The porous support layer has a large number of fine pores communicating with each other. A pore diameter and a pore diameter distribution of the fine pores are not particularly limited, and for example, it is preferable that the porous support layer has a symmetric structure having a uniform pore diameter, or an asymmetric structure in which the pore diameter gradually increases from one surface to the other surface, and the pore diameter on the surface having a smaller pore diameter is 0.1 nm to 100 nm.

As the material of the porous support layer, homopolymers or copolymers such as polysulfones (hereinafter also referred to as “PSf”), polyethersulfones, polyamides, polyesters, cellulose-based polymers, vinyl polymers, polyphenylene sulfides, polyphenylene sulfide sulfones, polyphenylene sulfones, and polyphenylene oxides can be used alone or blended for use. Examples of the cellulose-based polymer include cellulose acetate and cellulose nitrate, and examples of the vinyl polymer include polyethylene, polypropylene, polyvinyl chloride, and polyacrylonitrile. Among these, homopolymers or copolymers such as PSf, polyamides, polyesters, cellulose acetate, cellulose nitrate, polyvinyl chloride, polyacrylonitrile, polyphenylene sulfides, polyphenylene sulfide sulfones are preferable, cellulose acetate, PSf, polyphenylene sulfide sulfones, or polyphenylene sulfones are more preferable, and PSf is particularly preferable because PSf has high chemical, mechanical, and thermal stability and is easily molded.

A weight average molecular weight (hereinafter also referred to as “Mw”) of PSf is preferably 10,000 to 200,000, and more preferably 15,000 to 100,000. When Mw of PSf is 10,000 or more, preferable mechanical strength and heat resistance can be obtained for a porous support layer. On the other hand, when Mw of PSf is 200,000 or less, the viscosity of a porous support layer raw liquid is in an appropriate range, and good moldability can be realized.

The support membrane may have a substrate in addition to the porous support layer.

Examples of materials of the substrate include fabrics including polyester-based polymers, polyamide-based polymers, polyolefin-based polymers and mixtures thereof, or copolymers thereof. Among them, a fabric including polyester-based polymers having high mechanical and thermal stability is preferable. As the form of fabric, a long-fiber nonwoven fabric or a short-fiber nonwoven fabric, or a woven knitted fabric can be preferably used.

A thickness of the support membrane influences the strength of the composite semipermeable membrane and filling density when the composite semipermeable membrane is used for an element. In order to obtain good mechanical strength and filling density, the thickness of the support membrane is preferably 50 μm to 300 μm, and more preferably 100 μm to 250 μm. When the support membrane is composed of the porous support layer and the substrate, a thickness of the porous support layer is preferably 20 μm to 100 μm. The thickness of the support membrane can be obtained by calculating an average value of thicknesses at 20 points measured at an interval of 20 μm in a direction (surface direction of the membrane) orthogonal to a thickness direction in cross-sectional observation.

### (1-2) Separation Functional Layer

A separation functional layer is disposed on a support membrane. The separation functional layer included in the composite semipermeable membrane according to the present embodiment is a layer that functions to separate a solute, and contains a crosslinked polyamide. A proportion of the crosslinked polyamide in the separation functional layer is preferably 50 mass % or more, more preferably 80 mass % or more, and still more preferably 90 mass % or more. The content of the crosslinked polyamide in the separation functional layer can be generally calculated by analysis using a nuclear magnetic resonance method.

The crosslinked polyamide is preferably a polycondensate of a polyfunctional amine and a polyfunctional acid chloride. Here, at least one of the polyfunctional amine and the polyfunctional acid chloride preferably contains a trifunctional or higher functional compound. Accordingly, a rigid molecular chain is obtained, and a good pore structure for removing fine solutes such as hydrated ions or silica is formed.

The polyfunctional amine refers to an amine having at least two primary amino groups and/or secondary amino groups in one molecule. Examples of the polyfunctional amine include aromatic trifunctional amines such as 1,3,5-triaminobenzene and 1,2,4-triaminobenzene, aromatic bifunctional amines such as o-phenylenediamine, m-phenylenediamine (hereinafter, also referred to as “m-PDA”), p-phenylenediamine, o-xylylenediamine, m-xylylenediamine, p-xylylenediamine, o-diaminopyridine, m-diaminopyridine, p-diaminopyridine, 3,5-diaminobenzoic acid, 2,4-diaminobenzenesulfonic acid, 3-aminobenzylamine, and 4-aminobenzylamine, and aliphatic bifunctional amines such as ethylenediamine, propylenediamine, 1,4-diaminocyclohexane, piperazine, 2,5-dimethylpiperazine, 4-aminopiperidine, and aminoethylpiperazine. These polyfunctional amines may be used alone or in combination of two or more thereof.

From the viewpoint of the separation performance, water permeability, and heat resistance of the composite semipermeable membrane, the polyfunctional amine is preferably m-PDA, p-phenylenediamine, or 1,3,5-triaminobenzene. Among them, m-PDA is particularly preferable from the viewpoint of availability and handleability.

The polyfunctional acid chloride refers to an acid chloride having at least two chlorocarbonyl groups in one molecule. Examples of the polyfunctional acid chloride include aromatic trifunctional acid chlorides such as trimesic acid chloride (hereinafter also referred to as “TMC”) and trimellitic acid chloride, aliphatic trifunctional acid chlorides such as 1,3,5-cyclohexanetricarboxylic acid trichloride, aromatic bifunctional acid chlorides such as biphenyldicarboxylic acid chloride, azobenzenedicarboxylic acid dichloride, terephthalic acid chloride, isophthalic acid chloride, and 2,6-naphthalenedicarboxylic acid dichloride, and aliphatic bifunctional acid chlorides such as adipoyl chloride, sebacoyl chloride, and 1,4-cyclohexanedicarboxylic acid dichloride. These polyfunctional acid chlorides may be used alone or in combination of two or more thereof.

From the viewpoint of separation performance and heat resistance of the composite semipermeable membrane, the polyfunctional acid chloride is preferably a polyfunctional aromatic acid chloride having 2 to 4 chlorocarbonyl groups in one molecule. Among them, TMC is particularly preferable from the viewpoint of availability and handleability.

### (1-3) Coating Layer

A coating layer included in the composite semipermeable membrane according to the present embodiment is a layer that protects the separation functional layer, and is disposed on the separation functional layer. The coating layer includes a vinyl alcohol copolymer containing a structure represented by the following general formula (1) (hereinafter, also simply referred to as a “vinyl alcohol copolymer”).

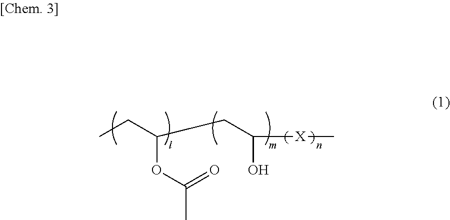

In the general formula (1), X is a divalent hydrocarbon group having 2 to 6 carbon atoms, and l, m and n are the number of repeating units.

The vinyl alcohol copolymer contains the structure represented by the general formula (1), and may contain other structures. A proportion of the structure represented by the general formula (1) in the vinyl alcohol copolymer is preferably 60 mass % or more, more preferably 70 mass % or more, still more preferably 80 mass % or more, and particularly preferably composed of only the structure represented by the general formula (1). The proportion of the structure represented by the general formula (1) in the vinyl alcohol copolymer can be generally calculated by analysis using a nuclear magnetic resonance method.

The vinyl alcohol copolymer containing the structure represented by the general formula (1) exhibits a hydrophobic interaction between hydrocarbons, in addition to an intermolecular hydrogen bond between hydroxyl groups shown by a polyvinyl alcohol having only a hydroxyl group and an acetate group as functional groups (hereinafter also referred to as “PVA”). Accordingly, the vinyl alcohol copolymer has a stronger intermolecular interaction than PVA, and a higher-order structure formed by the vinyl alcohol copolymer due to intermolecular interaction or the like is less likely to change during washing using an acid or an alkali. Therefore, by providing the coating layer containing the vinyl alcohol copolymer, a composite semipermeable membrane having good acid resistance and alkali resistance can be obtained. Further, as disclosed in “Journal of Membrane Science”, vol. 501, 2016, P. 209 to 219 or “Desalination”, vol. 367, 2015, P. 11 to 20, the hydroxyl group of PVA forms a hydrogen bond with the terminal amino group of the crosslinked polyamide of the separation functional layer or the amide group of the skeleton, thereby preventing oxidation of the crosslinked polyamide. In addition, as described above, since the higher-order structure of the vinyl alcohol copolymer is less likely to change than that of PVA, this hydrogen bond is easily maintained. Therefore, by using the vinyl alcohol copolymer in the coating layer, it is possible to obtain a composite semipermeable membrane having a low risk of oxidative deterioration due to leakage of the oxidizing agent and good oxidation resistance.

By coating the composite semipermeable membrane with the vinyl alcohol copolymer, a composite semipermeable membrane that is less likely to undergo chemical fouling can be obtained. In addition, by preventing chemical fouling, it is possible to prevent the propagation of microorganisms using organic substances as food, and thus a composite semipermeable membrane that is resistant to biofouling can be obtained. Furthermore, since the vinyl alcohol copolymer has hydrophilicity, a decrease in water permeability due to the coating layer is small, and a composite semipermeable membrane having sufficient water permeability can be obtained.

In the general formula (1), examples of the divalent hydrocarbon group having 2 to 6 carbon atoms of X include an ethylene group (—CH₂CH₂—), an ethylidene group (—CH(CH₃)—), a vinylene group (—CH═CH—), a trimethylene group (—CH₂CH₂CH₂—), a propylene group (—CH(CH₃)CH₂—), a tetramethylene group (—CH₂(CH₂)₂CH₂—), a cyclopentylene group, and a hexamethylene group (—CH₂ (CH₂)₄CH₂—). X in the general formula (1) is preferably a divalent hydrocarbon group having 2 carbon atoms. When X in the general formula (1) is a divalent hydrocarbon group having 2 carbon atoms, the vinyl alcohol copolymer has sufficient water solubility, and the coating layer can be easily formed on the separation functional layer using a vinyl alcohol copolymer aqueous solution in a “(2-3) coating layer formation step” to be described later. X in the general formula (1) is preferably a divalent saturated hydrocarbon group having 2 to 6 carbon atoms. When X in the general formula (1) is a divalent saturated hydrocarbon group having 2 to 6 carbon atoms, a coating layer that is hardly deteriorated by oxidation or the like can be formed. Among them, from the viewpoint of availability, X in the general formula (1) is particularly preferably an ethylene group.

A copolymerization ratio n/(l+m+n) of the vinyl alcohol copolymer containing the structure represented by the general formula (1) contained in the coating layer of the composite semipermeable membrane according to the present embodiment is preferably 0.035 to 0.16, more preferably 0.040 to 0.11, and still more preferably 0.042 to 0.095. When the copolymerization ratio is 0.035 or more, the vinyl alcohol copolymer exhibits strong intermolecular interaction by sufficient hydrophobic interaction, and a composite semipermeable membrane having good oxidation resistance, acid resistance, and alkali resistance can be obtained. On the other hand, when the copolymerization ratio is 0.16 or less, the vinyl alcohol copolymer has sufficient water solubility, and a coating layer can be easily formed on a separation functional layer using a vinyl alcohol copolymer aqueous solution in the “(2-3) coating layer formation step” to be described later. The copolymerization ratio can be generally calculated by analysis using a nuclear magnetic resonance method.

The coating layer may contain, in addition to the vinyl alcohol copolymer, hydrophilic polymers such as PVA and polyacrylic acid (hereinafter also referred to as “PAA”).

A proportion of the vinyl alcohol copolymer in the coating layer of the composite semipermeable membrane according to the present embodiment is preferably 50 mass % or more, more preferably 60 mass % or more, and still more preferably 70 mass % or more. When the proportion of the vinyl alcohol copolymer in the coating layer is 50 mass % or more, a composite semipermeable membrane having good oxidation resistance, acid resistance, and alkali resistance can be obtained.

The proportion of the vinyl alcohol copolymer in the coating layer can be generally calculated by analysis using a nuclear magnetic resonance method.

A degree of saponification {m/(l+m)×100} of the vinyl alcohol copolymer is preferably 96 mol % or more, and more preferably 98 mol % or more. When the degree of saponification of the vinyl alcohol copolymer is 96 mol % or more, that is, when the vinyl alcohol copolymer has more hydroxyl groups, the intermolecular hydrogen bond of the vinyl alcohol copolymer and the hydrogen bond with the crosslinked polyamide are strengthened, and thus a composite semipermeable membrane having good oxidation resistance, acid resistance, and alkali resistance can be obtained.

A degree of polymerization l+m+n of the vinyl alcohol copolymer is preferably 100 to 1,500, and more preferably 200 to 1,200. When the degree of polymerization of the vinyl alcohol copolymer is 100 or more, a coating layer having a sufficient thickness can be provided, and a composite semipermeable membrane having excellent fouling resistance can be obtained. On the other hand, when the degree of polymerization of the vinyl alcohol copolymer is 1,500 or less, the permeation resistance due to the thickness of the coating layer can be prevented, and a composite semipermeable membrane having sufficient water permeability can be obtained. In addition, when the degree of polymerization is within the above range, the vinyl alcohol copolymer has sufficient water solubility, and a coating layer can be easily formed on the separation functional layer using the vinyl alcohol copolymer aqueous solution in the “(2-3) coating layer formation step” to be described later.

The coating layer is preferably insolubilized so as not to be eluted when the composite semipermeable membrane is used. Examples of a method of insolubilizing a coating layer include a method of forming a non-covalent bond such as a hydrogen bond or an ionic bond with a crosslinked polyamide and immobilizing the coating layer on the separation functional layer, a method of forming a covalent bond by a crosslinked polyamide and a crosslinking agent and immobilizing the coating layer on the separation functional layer, and a method of forming a covalent bond by a crosslinking agent between coating layers and insolubilizing the coating layer as a three-dimensional structure. Among them, from the viewpoint that stable operation can be continued over a long period of time, a method of forming a covalent bond by a crosslinked polyamide, a crosslinking agent or the like and immobilizing a coating layer on a separation functional layer is more preferable.

The shapes and thicknesses of the separation functional layer and the coating layer influence the separation performance and the water permeability. FIG. 2 shows a second mode of a structure of the composite semipermeable membrane 1 according to the present embodiment. As shown in (a) and (b) of FIG. 2, the separation functional layer 3 preferably has a pleated shape having a plurality of convex portions. A convex portion interior 5 (between the separation functional layer 3 and the support membrane 2) is more preferably a void. Since a surface area of the separation functional layer 3 can be made larger when the separation functional layer 3 has a pleated shape than when the separation functional layer 3 has a flat shape, the separation functional layer 3 can have high water permeability while maintaining the separation performance. The coating layer 4 may be thinly formed on the separation functional layer 3 to form a pleated shape together with the separation functional layer 3, or may have a relatively large thickness to fill the pleated shape of the separation functional layer 3.

A root mean square height (hereinafter also referred to as “Sq”) of a coating layer-side surface of the composite semipermeable membrane is preferably 60 nm to 300 nm, more preferably 100 nm to 280 nm, and still more preferably 140 nm to 260 nm. When Sq is 60 nm or more, the surface area of the separation functional layer increases, and a composite semipermeable membrane having good water permeability can be obtained. On the other hand, when Sq is 300 nm or less, the pleated shape can be maintained even under high-pressure operating conditions in seawater desalination applications and the like, and a composite semipermeable membrane having good water permeability can be obtained.

A total thickness T of the separation functional layer and the coating layer is preferably 10 nm to 100 nm, more preferably 11 nm to 70 nm, and still more preferably 11 nm to 20 nm. When a total thickness T of the separation functional layer and the coating layer is 10 nm or more, a composite semipermeable membrane having good separation performance can be obtained. On the other hand, when the total thickness T of the separation functional layer and the coating layer is 100 nm or less, a composite semipermeable membrane having good water permeability can be obtained. As shown in (b) of FIG. 2, the “total thickness T” means a thickness from the convex portion interior 5 to the outside in a case where the separation functional layer 3 and the coating layer 4 overlap and are integrated and the separation functional layer and the coating layer have a pleated shape including a plurality of hollow convex portions.

In order to prevent a substance to be separated from penetrating into the composite semipermeable membrane, the separation functional layer and the coating layer are preferably disposed on a surface side of the composite semipermeable membrane, and the surface side of the composite semipermeable membrane on which the separation functional layer is disposed is preferably used as a filtration primary side.

The helium permeability of the composite semipermeable membrane according to the present embodiment is influenced by the crystallinity of the vinyl alcohol copolymer contained in the coating layer and the intermolecular interaction of an amorphous portion. The low helium permeability of the composite semipermeable membrane, that is, the coating layer having excellent gas barrier properties, means that a degree of crystallinity of the vinyl alcohol copolymer contained in the coating layer is high and the intermolecular interaction of the amorphous portion is strong. As the degree of crystallinity of the vinyl alcohol copolymer contained in the coating layer is higher and the intermolecular interaction of the amorphous portion is stronger, the higher-order structure of the coating layer is less likely to change during washing using an acid or an alkali. As a result, a composite semipermeable membrane having good oxidation resistance, acid resistance, and alkali resistance can be obtained. On the other hand, when the helium permeability of the composite semipermeable membrane is extremely low, the water permeability of the composite semipermeable membrane also decreases.

Specifically, a ratio of the water permeability (m/d/MPa) to the helium permeability (m/d/MPa) of the composite semipermeable membrane (hereinafter, also referred to as “water permeability/helium permeability”) is preferably 0.0105 to 0.0400, more preferably 0.0106 to 0.0300, and still more preferably 0.0108 to 0.0250. Here, “water permeability” and “helium permeability” mean values measured by methods described in “(1) water permeability” and “(8) gas permeability and selectivity” to be described later.

When the water permeability/helium permeability of the composite semipermeable membrane is 0.0105 or more, it is possible to obtain a composite semipermeable membrane having both excellent water permeability and good acid resistance, alkali resistance, and oxidation resistance. On the other hand, when the water permeability/helium permeability of the composite semipermeable membrane is 0.0400 or less, a composite semipermeable membrane having sufficient water permeability can be obtained.

He/O₂ selectivity of the composite semipermeable membrane according to the present embodiment is preferably 7.5 to 10.4, more preferably 7.8 to 10.2, and still more preferably 8.0 to 10.0. Here, the term “He/O₂ selectivity” means the helium permeability with respect to the oxygen permeability of the composite semipermeable membrane measured by the method described in “(8) gas permeability and selectivity” to be described later.

The He/O₂ selectivity of the composite semipermeable membrane correlates with the separation performance and water permeability of the composite semipermeable membrane. When the He/O₂ selectivity of the composite semipermeable membrane is 7.5 or more, a composite semipermeable membrane having good separation performance can be obtained. On the other hand, when the He/O₂ selectivity of the composite semipermeable membrane is 10.4 or less, a composite semipermeable membrane having sufficient water permeability can be obtained.

In the composite semipermeable membrane according to the present embodiment, an adhesive strength when the coating layers of the two composite semipermeable membranes are attached to each other (hereinafter, also referred to as “adhesive strength between the coating layers”) is preferably 0.9 N/25 mm to 5.0 N/25 mm, more preferably 1.4 N/25 mm to 4.0 N/25 mm, and still more preferably 2.0 N/25 mm to 3.5 N/25 mm.

The adhesive strength between the coating layers is influenced by the intermolecular interaction of the vinyl alcohol copolymer contained in the coating layer. The high adhesive strength between the coating layers means that the vinyl alcohol copolymer contained in the coating layer forms a strong intermolecular interaction. As the intermolecular interaction of the vinyl alcohol copolymer contained in the coating layer is stronger, the higher-order structure of the coating layer is less likely to change during washing using an acid or an alkali. As a result, a composite semipermeable membrane having good oxidation resistance, acid resistance, and alkali resistance can be obtained. On the other hand, when the adhesive strength between the coating layers is too strong, the permeation resistance of the coating layer increases, and thus the water permeability of the composite semipermeable membrane decreases. When the adhesive strength between the coating layers is 0.9 N/25 mm or more, a composite semipermeable membrane having good oxidation resistance, acid resistance, and alkali resistance can be obtained. On the other hand, when the adhesive strength between the coating layers is 5.0 N/25 mm or less, a composite semipermeable membrane having sufficient water permeability can be obtained. The measurement conditions of the adhesive strength are as described in “(9) adhesive strength” below.

### (1-4) NaCl Removal Rate and Water Permeability

A NaCl removal rate of the composite semipermeable membrane according to the present embodiment is preferably 99.55% or more, more preferably 99.65% or more, and still more preferably 99.75% or more. A water permeability F₀ of the composite semipermeable membrane is preferably 0.65 m/d/MPa or more, more preferably 0.75 m/d/MPa or more, and still more preferably 0.85 m/d/MPa or more. When the membrane performance of the composite semipermeable membrane is within the above range, the composite semipermeable membrane can be preferably used as a separation membrane for separation of salts and the like.

A water permeability F₁ of the composite semipermeable membrane after fouling is preferably 0.50 m/d/MPa or more, more preferably 0.60 m/d/MPa or more, and still more preferably 0.70 m/d/MPa or more. Further, the water permeability F₁ after fouling to the water permeability F₀ of the composite semipermeable membrane (hereinafter, also referred to as “F₁/F₀”) is preferably 0.7 or more, and more preferably 0.8 or more.

When the membrane performance of the composite semipermeable membrane after the fouling treatment is within the above range, the composite semipermeable membrane can be preferably used as a composite semipermeable membrane having excellent fouling resistance. The fouling conditions are as described in “(3) water permeability after fouling” below.

A NaCl removal rate of the composite semipermeable membrane according to the present embodiment after being brought into contact with the oxidizing agent is preferably 99.50% or more, more preferably 99.60% or more, and still more preferably 99.70% or more. When the membrane performance of the composite semipermeable membrane after being brought into contact with the oxidizing agent is within the above range, the composite semipermeable membrane can be preferably used as a composite semipermeable membrane having a low risk of oxidative deterioration due to leakage of the oxidizing agent. The conditions for the composite semipermeable membrane brought into contact with the oxidizing agent are as described in “(6) oxidizing agent contact” to be described later.

A NaCl removal rate of the composite semipermeable membrane according to the present embodiment after being brought into contact with an acid or alkali is preferably 99.40% or more, more preferably 99.50% or more, and still more preferably 99.60% or more. When the membrane performance of the composite semipermeable membrane after being brought into contact with an acid or alkali is within the above range, the composite semipermeable membrane can be preferably used as a composite semipermeable membrane that maintains separation performance even after repeated chemical washing. The conditions for the composite semipermeable membrane brought into contact with the acid or alkali are as described in “(4) alkali contact” or “(5) acid contact” to be described later.

Further, a NaCl removal rate of the composite semipermeable membrane according to the present embodiment after the membrane deterioration test is preferably 99.15% or more, more preferably 99.30% or more, and still more preferably 99.40% or more. When the membrane performance of the composite semipermeable membrane after the membrane deterioration test is within the above range, the composite semipermeable membrane can be preferably used as a composite semipermeable membrane having a low risk of composite deterioration due to the alkali, the acid, and the oxidizing agent. The conditions of the membrane deterioration test are as described in a “(7) membrane deterioration test” to be described later.

### 2. Method for Producing Composite Semipermeable Membrane

A method for producing a composite semipermeable membrane according to the present embodiment is not particularly limited as long as a composite semipermeable membrane that satisfies the above-described desired characteristics can be obtained, and the composite semipermeable membrane may be produced, for example, by the following method.

### (2-1) Formation of Support Membrane

As a method for forming a support membrane, a known method can be suitably used. Hereinafter, a case where PSf is used as the material of the porous support layer will be described as an example.

First, PSf is dissolved in a good solvent of PSf to prepare a porous support layer raw liquid. As the good solvent of PSf, for example, N, N-dimethylformamide (hereinafter, referred to as “DMF”) is preferable.

A concentration of PSf in the porous support layer raw liquid is preferably 10 mass % to 25 mass %, and more preferably 12 mass % to 20 mass %. When the concentration of PSf in the porous support layer raw liquid is within this range, it is possible to achieve both the strength and the water permeability of the obtained porous support layer. A preferable range of a concentration of the material in the porous support layer raw liquid can be appropriately adjusted according to the material to be used, the good solvent, and the like.

Next, the obtained porous support layer raw liquid is applied to a surface of the substrate, and is immersed in a coagulation bath containing a non-solvent of PSf.

The non-solvent of PSf contained in the coagulation bath is preferably water, for example. By bringing the porous support layer raw liquid applied on the surface of the substrate into contact with the coagulation bath containing the non-solvent of PSf, the porous support layer raw liquid is solidified by the non-solvent induced phase separation, and a support membrane in which a porous support layer is formed on the surface of the substrate can be obtained.

The coagulation bath may be composed of only the non-solvent of PSf, or may contain the good solvent of PSf in a range in which the porous support layer raw liquid can be coagulated.

By washing the obtained support membrane before the formation of the separation functional layer, the solvent remaining in the support membrane may be removed.

### (2-2) Polymerization Step of Separation Functional Layer

Next, a separation functional layer containing a crosslinked polyamide is formed on a support membrane

As a method for forming a separation functional layer containing a crosslinked polyamide, a method for polymerizing and solidifying a polyfunctional amine and a polyfunctional acid chloride on the support membrane obtained by “(2-1) formation of support membrane” will be described as an example. As a polymerization method, an interfacial polymerization method is most preferable from the viewpoint of productivity and performance. An interfacial polymerization step is described below.

The interfacial polymerization step includes (a) a step of bringing an aqueous solution containing a polyfunctional amine into contact with a support membrane, (b) a step of bringing an organic solvent solution containing a polyfunctional acid chloride into contact with the support membrane that has been brought into contact with the aqueous solution containing a polyfunctional amine, (c) a step of draining the organic solvent solution after the contact, and (d) a step of washing, with hot water, the composite semipermeable membrane obtained by draining the organic solvent solution.

In the step (a), the aqueous solution contains at least a polyfunctional amine. Examples of the polyfunctional amine include the polyfunctional amine exemplified in “(1-2) separation functional layer”.

A concentration of the polyfunctional amine in the aqueous solution is preferably 0.1 mass % to 20 mass %, more preferably 0.5 mass % to 15 mass %, and still more preferably 1.0 mass % to 10 mass %. When the concentration of the polyfunctional amine is 0.1 mass % or more, a separation functional layer having a solute separation performance can be formed. On the other hand, when the concentration of the polyfunctional amine is 20 mass % or less, a separation functional layer having good water permeability can be formed.

The aqueous solution may contain a compound such as a surfactant and an antioxidant as necessary as long as the polymerization is not inhibited.

The aqueous solution is preferably brought into contact with the support membrane uniformly and continuously. Specific examples thereof include a method of coating a support membrane with a polyfunctional amine aqueous solution, and a method of immersing a support membrane in an aqueous solution. A contact time between the support membrane and the aqueous solution is preferably 1 second to 10 minutes, and more preferably 3 seconds to 3 minutes.

After the aqueous solution is brought into contact with the support membrane, it is preferable to sufficiently drain liquid such that no droplet remains on the support membrane. By sufficiently draining liquid, it is possible to prevent droplet residue from becoming a membrane defect after separation functional layer formation and deteriorating separation performance. Examples of a liquid draining method include, a method of holding the support membrane in a vertical direction after the contact with the aqueous solution and allowing the excess aqueous solution to naturally flow down, or a method of forcibly draining solution by blowing an air flow such as nitrogen from an air nozzle. In addition, after the liquid draining, the membrane surface may be dried to partially remove water of the aqueous solution.

In the step (b), examples of the polyfunctional acid chloride include the polyfunctional acid chlorides exemplified in “(1-2) separation functional layer”.

The organic solvent is preferably immiscible with water, dissolves the polyfunctional acid chloride, does not erode the support membrane, and is inactive to the polyfunctional amine and the polyfunctional acid chloride. Examples of the organic solvent include hydrocarbon compounds such as n-nonane, n-decane, n-undecane, n-dodecane, isooctane, isodecane, and isododecane, and mixed solvents thereof.

A concentration of the polyfunctional acid chloride in the organic solvent solution is preferably 0.01 mass % to 10 mass %, more preferably 0.02 mass % to 4 mass %, and still more preferably 0.03 mass % to 2 mass %. When the concentration of the polyfunctional acid chloride is 0.01 mass % or more, the polymerization can proceed at a sufficient reaction rate. On the other hand, when the concentration of the polyfunctional acid chloride is 10 mass % or less, a side reaction during polymerization can be prevented. The organic solvent solution may contain a compound such as a surfactant as necessary as long as the polymerization is not inhibited.

The organic solvent solution of the polyfunctional acid chloride is preferably brought into contact with the support membrane, that has been brought into contact with the polyfunctional amine aqueous solution, uniformly and continuously. Specifically, for example, a method of coating a support membrane that has been brought into contact with a polyfunctional amine aqueous solution with an organic solvent solution of a polyfunctional acid chloride is exemplified. A contact time between the support membrane that has been brought into contact with the polyfunctional amine aqueous solution and the organic solvent solution of the polyfunctional acid chloride is preferably 3 seconds to 10 minutes, and more preferably 5 seconds to 3 minutes.

If necessary, the support membrane that has been brought into contact with the organic solvent solution of polyfunctional acid chloride may be heat-treated. In the case of heat treatment, a heating temperature is preferably 35° C. to 180° C., more preferably 50° C. to 160° C., still more preferably 60° C. to 150° C. A suitable heating time varies depending on a temperature of the membrane surface as a reaction field, and is preferably 5 seconds or longer, more preferably 10 seconds or longer.

In the step (c), the organic solvent solution on the composite semipermeable membrane after the polymerization reaction is removed by draining. Examples of the liquid draining method include a method of holding a membrane in a vertical direction to remove an excess organic solvent solution by allowing the excess organic solvent solution to naturally flow down, a method of drying and removing an organic solvent by blowing air with a blower, or a method of removing an excess organic solvent solution with a mixed fluid of water and air.

In step (d), the composite semipermeable membrane from which the organic solvent is removed is washed with hot water. A temperature of the hot water is preferably 40° C. to 95° C., and more preferably 60° C. to 95° C. When the temperature of the hot water is 40° C. or higher, unreacted substances and oligomers remaining in the membrane can be sufficiently removed. On the other hand, when the temperature of the hot water is 95° C. or lower, a shrinkage degree of the composite semipermeable membrane does not increase, and good water permeability can be maintained. A preferred range of the temperature of the hot water can be appropriately adjusted according to the polyfunctional amine or the polyfunctional acid chloride to be used.

### (2-3) Coating Layer Formation Step

Next, a coating layer containing a vinyl alcohol copolymer is formed on the separation functional layer.

As a method for forming a coating layer containing a vinyl alcohol copolymer, a method in which a solution containing the vinyl alcohol copolymer is brought into contact with the separation functional layer obtained in the “(2-2) polymerization step of separation functional layer” to insolubilize the vinyl alcohol copolymer will be described as an example.

The coating layer formation step includes (e) a step of bringing a solution containing a vinyl alcohol copolymer and a crosslinking agent into contact with the separation functional layer, (f) a step of crosslinking the vinyl alcohol copolymer with a crosslinked polyamide and immobilizing the vinyl alcohol copolymer on the separation functional layer, (g) a step of draining the excess solution, and (h) a step of washing the composite semipermeable membrane.

In the step (e), the solution contains at least a vinyl alcohol copolymer and a crosslinking agent. From the viewpoint of preventing deterioration of the separation functional layer and the support membrane during solution contact, it is preferable to use water as a solution in which the vinyl alcohol copolymer and the crosslinking agent are dissolved. An additive may be used to improve the solubility of the vinyl alcohol copolymer.

A concentration of the vinyl alcohol copolymer in the solution is preferably 0.05 mass % to 10 mass %, more preferably 0.1 mass % to 8 mass %, and still more preferably 0.2 mass % to 5 mass %. When the concentration of the vinyl alcohol copolymer is 0.05 mass % or more, a coating layer having a sufficient thickness can be provided, and a composite semipermeable membrane having excellent fouling resistance can be obtained. On the other hand, when the concentration of the vinyl alcohol copolymer is 10 mass % or less, a decrease in water permeability due to the coating layer can be prevented, and a composite semipermeable membrane having sufficient water permeability can be obtained.

The solution may contain a component for forming a coating layer other than the vinyl alcohol copolymer, for example, PVA or PAA.

The “crosslinking agent” means a compound that reacts with a functional group of the vinyl alcohol copolymer and a functional group of the crosslinked polyamide to form a covalent bond with both of them. Examples of the crosslinking agent include polyvalent aldehydes such as succinaldehyde, glutaraldehyde, and terephthaldehyde.

A concentration of the crosslinking agent in the solution is preferably 0.01 mass % to 5 mass %, more preferably 0.02 mass % to 1 mass %, and still more preferably 0.05 mass % to 0.5 mass %. When the concentration of the crosslinking agent is 0.01 mass % or more, the vinyl alcohol copolymer and the crosslinked polyamide form a covalent bond, and the vinyl alcohol copolymer can be insolubilized. On the other hand, when the concentration of the crosslinking agent is 5 mass % or less, the rapid progress of the crosslinking reaction can be prevented, and a uniform coating layer can be formed.

The aqueous solution may contain a compound such as a catalyst as necessary. When a polyvalent aldehyde is used as a crosslinking agent for the vinyl alcohol copolymer, examples of the catalyst include inorganic acids such as hydrochloric acid and sulfuric acid.

The solution is preferably brought into contact with the separation functional layer uniformly and continuously. Specifically, for example, a method of coating a separation functional layer with a solution is exemplified. A contact time between the separation functional layer and the solution is preferably 5 seconds to 10 hours, and more preferably 10 seconds to 1 hour.

In the step (f), the vinyl alcohol copolymer is crosslinked with the crosslinked polyamide of the separation functional layer to be insolubilized. A crosslinking method can be appropriately selected depending on the crosslinking agent to be used. When a polyvalent aldehyde is used as the crosslinking agent, the crosslinking method is preferably thermal crosslinking. Examples of the thermal crosslinking method include a method of heating the aqueous solution and the composite semipermeable membrane by blowing hot air with a blower. A temperature of the hot air is preferably 30° C. to 120° C., and more preferably 40° C. to 80° C. When the temperature of the hot air is 30° C. or higher, the vinyl alcohol copolymer and the crosslinked polyamide form a covalent bond, and the vinyl alcohol copolymer can be insolubilized. On the other hand, when the temperature of the hot air is 120° C. or lower, the rapid progress of the crosslinking reaction can be prevented, a uniform coating layer can be formed, the shrinkage degree of the composite semipermeable membrane does not increase, and good water permeability can be maintained.

In step (g), the solution on the composite semipermeable membrane after the crosslinking reaction is removed by draining. Examples of the liquid draining method include a method of holding a membrane in a vertical direction and removing an excess solution by allowing the excess solution to naturally flow down, and a method of drying and removing a solvent by blowing air with a blower.

In the step (h), the composite semipermeable membrane from which the solution is removed is washed with water. A temperature of water used for washing is preferably 15° C. to 70° C., and more preferably 20° C. to 50° C. When the temperature of the water is 15° C. or higher, unreacted materials, catalysts, and the like remaining in the composite semipermeable membrane can be sufficiently removed. On the other hand, when the temperature of the hot water is 70° C. or lower, a shrinkage degree of the composite semipermeable membrane does not increase, and good water permeability can be maintained. A preferred range of the temperature of the water can be appropriately adjusted depending on a type of a vinyl alcohol copolymer or crosslinking agent to be used.

If necessary, the composite semipermeable membrane may be subjected to hydrophilization treatment. Examples of a hydrophilization treatment method include a method of bringing a surfactant aqueous solution such as polyoxyethylene octylphenyl ether or sodium n-dodecylbenzenesulfonate or an alcohol aqueous solution such as methanol, ethanol, isopropanol, or glycerin into contact with a composite semipermeable membrane.

### 3. Use of Composite Semipermeable Membrane

The composite semipermeable membrane according to the present embodiment is wound around a tubular water collection pipe in which a large number of holes are bored together with a feed water channel material such as a plastic net, a permeate channel material such as a tricot, and a film for increasing pressure resistance as necessary, to be suitably used as a spiral type composite semipermeable membrane element. Furthermore, a composite semipermeable membrane module in which these elements are connected in series or in parallel and accommodated in a pressure vessel can also be provided.

The composite semipermeable membrane, the element thereof, and the module can constitute a fluid separation device in combination with a pump that supplies feed water thereto, a device that subjects the feed water to pretreatment, and the like. By using the fluid separation device, the feed water can be separated into permeated water such as drinking water and concentrated water that does not permeate through the membrane to obtain intended water.

Examples of the feed water to be treated by the composite semipermeable membrane according to the present embodiment include a liquid mixture containing 500 mg/L to 100 g/L of total dissolved solids (TDS) such as seawater, brackish water, and wastewater. In general, TDS indicates an amount of the total dissolved solids, and is represented by “mass/volume” or “mass ratio”. According to the definition, the total dissolved solids can be calculated from a weight of residue obtained by evaporating, at a temperature of 39.5° C. to 40.5° C., a solution filtered through a filter of 0.45 microns, and is more conveniently converted from practical salinity (S).

As an operation pressure of the fluid separation device increases, a solute removal rate increases but energy required for operation also increases. In addition, in consideration of durability of the composite semipermeable membrane, the operation pressure when water to be treated permeates through the composite semipermeable membrane is preferably 0.5 MPa to 10 MPa. The solute removal rate decreases as a temperature of the feed water increases, but the water permeability decreases as the temperature of the feed water decreases. Therefore, the temperature of the feed water is preferably 5° C. to 45° C. In the case of feed water having a high solute concentration such as seawater, when the pH of the feed water becomes high, scale such as magnesium may be generated. Since there is concern about deterioration of the composite semipermeable membrane due to operation under a high pH condition, it is preferable to operate in a neutral region.

### EXAMPLES

Hereinafter, the present invention will be described with reference to specific examples, but the present invention is not limited to these examples.

Physical properties of the composite semipermeable membrane of the present invention were measured by the following method.

### (1) Water Permeability

Evaluation water (hereinafter, also referred to as “evaluation water”) prepared to a NaCl concentration of 2,000 mg/L, 25° C., and pH 7 was supplied to a composite semipermeable membrane having a diameter of 75 mm at an operation pressure of 1.55 MPa, and after operation for 2 hours, permeated water was collected for 15 minutes. An amount of permeated water (m³) was measured and converted into a numerical value per unit membrane area (m²), unit time (d), and unit pressure (MPa) to calculate the water permeability F₀ (m/d/MPa).

### (2) NaCl Removal Rate

In a membrane filtration test of “(1) water permeability”, the electric conductivity of the evaluation water and the permeated water was measured with a multi-water quality meter (manufactured by DKK-TOA CORPORATION, MM-60R), and the NaCl concentration (practical salinity) of each of the evaluation water and the permeated water was measured. The NaCl removal rate (%) was calculated from the obtained NaCl concentration based on the following Formula (1). A value rounded to the third decimal place was used.

$$NaCl removal rate ( \% ) = 100 \times \{ 1 - ( NaCl concentration in permeated water / \\ NaCl concentration in evaluation water ) \} \qquad Formula ( 1 )$$

### (3) Water Permeability After Fouling

Evaluation water in which polyoxyethylene (10) octylphenyl ether was added so as to have a concentration of 50 mg/L was supplied to the composite semipermeable membrane under the conditions described in “(1) water permeability”, and after operating for 30 minutes, permeated water was collected for 15 minutes. The water permeability F₁ (m/d/MPa) after fouling was calculated from the obtained permeated water by the same calculation method as in the “(1) water permeability”.

### (4) Alkali Contact

The composite semipermeable membrane was immersed in a sodium hydroxide aqueous solution adjusted to 25° C. and pH 12.5 for 72 hours and washed with distilled water.

### (5) Acid Contact

The composite semipermeable membrane was immersed in sulfuric acid adjusted to 25° C. and pH 2.0 for 3 hours and washed with distilled water.

### (6) Oxidizing Agent Contact

The composite semipermeable membrane was immersed in a 5 mg/L sodium hypochlorite aqueous solution adjusted to 25° C. and pH 7.0 for 96 hours in total while exchanging the aqueous solution every 24 hours. Thereafter, the composite semipermeable membrane was immersed in a 1000 mg/L sodium hydrogen sulfite aqueous solution for 10 minutes and washed with distilled water.

### (7) Membrane Deterioration Test

The composite semipermeable membrane was subjected to “(4) alkali contact”, “(5) acid contact”, “(6) oxidizing agent contact”, “(4) alkali contact”, and “(5) acid contact” in this order, and a NaCl removal rate (%) was calculated by the method described in the “(2) NaCl removal rate” in each stage.

### (8) Gas Permeability and Selectivity

The composite semipermeable membrane was cut out and dried to a water content of 0.5% or less. The composite semipermeable membrane was held between a supply-side cell and a permeation-side cell of a test cell including the supply-side cell and the permeation-side cell so that the separation functional layer and the coating layer were on the supply side. Using helium and oxygen as feed gases, changes in pressure of helium and oxygen per unit time on the permeation side were measured at a measurement temperature of 25° C. in accordance with a pressure sensor method of ISO 15105-1 (2007). Here, the feed side was set to 100 kPa, the permeation side was set to 0 kPa, and a pressure difference between the feed side and the permeation side was set to 100 kPa. Subsequently, the permeability (m/d/MPa) of helium and oxygen was calculated based on the following formula (2). STP means a standard condition.

Permeability (m/d/MPa) of helium or oxygen=[helium or oxygen permeation flow rate (m³·STP)]/[effective membrane area (m²) of composite semipermeable membrane x time (d)×pressure difference (MPa)] Formula (2)

The helium permeability was divided by the oxygen permeability to calculate the He/O₂ selectivity.

Details of the measurement conditions are shown below.
Effective membrane area of composite semipermeable membrane: 25 cm²
Cell temperature: 25° C.
Feed gas: mixed gas of helium and oxygen (volume ratio: 1:1), 0% RH

### (9) Adhesive Strength

Two composite semipermeable membranes each having a width of 25 mm and a length of 300 mm were cut out, washed with hot water at 90° C. for 5 minutes, and then immersed in distilled water at 20° C. for 10 minutes. A length of 220 mm from ends of the obtained two composite semipermeable membranes were attached so that the coating layers overlapped with each other, thereby preparing a test piece (hereinafter, also referred to as a “T-shape test piece”). The T-shape test piece was blown with hot air at 120° C. for 20 minutes and then immersed in water at 20° C. for 1 hour. Thereafter, in accordance with JIS K 6854-3 (1999), two ends of the T-shape test piece which were not attached to each other were held by a holding tool of a tensile tester (manufactured by A&D Co., Ltd., RTG-1210), and a T-shape peel test was performed under the following conditions.
Peeling speed: 200 mm/min
Peeling distance: 200 mm
Measurement room temperature: 25° C.

An average strength (N/25 mm) at a peeling distance of 50 mm to 150 mm was calculated. The same measurement was repeated 10 times after replacing the T-shape test piece, and an average value of the obtained average strength was defined as an adhesive strength (N/25 mm). However, in a case where the support membrane included a substrate and the substrate was peeled off while maintaining the adhesion between the coating layers, or in a case where a portion other than the coating layers was peeled off before the peeling distance reached 150 mm, a maximum strength when peeling occurred was defined as an average strength, and an adhesive strength was calculated.

(10) Total thickness T of Separation Functional Layer and Coating Layer

The composite semipermeable membrane was cut into a corner of 3 cm×3 cm and immersed with distilled water at 25° C. for 24 hours. The composite semipermeable membrane after immersion was embedded in an epoxy resin, dyed with osmium tetroxide, and cut into an ultrathin section using a microtome to prepare a measurement sample. The obtained sample was observed using a scanning transmission electron microscope (manufactured by Hitachi, Ltd.; HD 2700) with a composite semipermeable membrane cross-section as an observation surface. A shortest distance from a certain point on an outer surface of the separation functional layer or the coating layer to an inner surface was measured using the acquired image at a magnification of 1,000,000 times. With respect to 10 randomly selected convex portions, five points were measured for each convex portion, and an average value of the points was defined as the total thickness T (nm) of the separation functional layer and the coating layer.

(11) Root mean square height Sq of separation functional layer

The composite semipermeable membrane was cut into a corner of 3 cm×3 cm and immersed with distilled water at 25° C. for 24 hours. The composite semipermeable membrane after immersion was observed using an atomic force microscope (Dimension FastScan manufactured by Bruker) under the following conditions in a wet state with distilled water with the separation functional layer as a measurement surface. A root mean square height was calculated in accordance with surface properties (surface roughness measurement) of ISO 25178: 2014 at randomly selected 10 points, and an average value thereof was taken as the root mean square height Sq (nm).
Scanning mode: nano-mechanical mapping in water
Probe: silicon cantilever (Scan Asyst-Fluid manufactured by Bruker)
Maximum load: 5 nN
Scanning range: 10 μm×10 μm
Scanning speed: 1 Hz
Number of pixels: 512×512
Measurement environment: in distilled water
Measurement temperature: 25° C.

### (12) Weight Average Molecular Weight

The weight average molecular weight (in terms of polystyrene) of PSf was measured using gel permeation chromatography (manufactured by Tosoh Corporation; HLC-8022). Specific measurement conditions are as follows.
Column: two TSK gel SuperHM-H (manufactured by Tosoh Corporation; inner diameter: 6.0 mm, length: 15 cm)
Eluent: LiBr/N-methylpyrrolidone solution (10 mM)
Sample concentration: 0.1 mass %
Flow rate: 0.5 mL/min
Temperature: 40° C.

The raw materials of the composite semipermeable membranes used in Examples and Comparative Examples are summarized below.
PSf (manufactured by Solvay Specialty Polymers Japan K.K.; Udel P-3500, Mw 80,000)
DMF (manufactured by FUJIFILM Wako Pure Chemical Corporation)
Polyester filament nonwoven fabric (thickness: 90 μm, density: 0.42 g/cm³)
m-PDA (manufactured by FUJIFILM Wako Pure Chemical Corporation)
TMC (manufactured by FUJIFILM Wako Pure Chemical Corporation)
n-decane (manufactured by FUJIFILM Wako Pure Chemical Corporation)
Sodium nitrite (manufactured by FUJIFILM Wako Pure Chemical Corporation)
Sodium sulfite (manufactured by FUJIFILM Wako Pure Chemical Corporation)
Polyoxyethylene (10) octylphenyl ether (manufactured by FUJIFILM Wako Pure Chemical Corporation)
Sodium hypochlorite (manufactured by FUJIFILM Wako Pure Chemical Corporation)
Sodium hydrogen sulfite (manufactured by FUJIFILM Wako Pure Chemical Corporation)
Sulfuric acid (manufactured by FUJIFILM Wako Pure Chemical Corporation)
Sodium hydroxide aqueous solution (manufactured by FUJIFILM Wako Pure Chemical Corporation)
PAA (manufactured by FUJIFILM Wako Pure Chemical Corporation, Mw 25,000)
4-(4,6-dimethoxy-1,3,5-triazine-2-yl)-4-methylmorpholinium chloride (hereinafter also referred to as “DMT-MM”) (manufactured by FUJIFILM Wako Pure Chemical Corporation)
PVA 1 (manufactured by Sigma-Aldrich; degree of saponification: 99.5 mol %, degree of polymerization: 2,600)
PVA 2 (manufactured by Sigma-Aldrich; degree of saponification: 98.0 mol % to 99.0 mol %, degree of polymerization: 900)
PVA 3 (manufactured by Sigma-Aldrich; degree of saponification: 87.0 mol % to 89.0 mol %, degree of polymerization: 900)
Vinyl alcohol copolymer 1 (manufactured by Kuraray Co., Ltd.; Exceval RS-2117, degree of saponification: 97.5 mol % to 99.0 mol %, degree of polymerization: 1,700, ethylene copolymerization ratio: 0.030)
Vinyl alcohol copolymer 2 (manufactured by Kuraray Co., Ltd.; Exceval RS-1717, degree of saponification: 92.0 mol % to 94.0 mol %, degree of polymerization: 1,700, ethylene copolymerization ratio: 0.028)
Vinyl alcohol copolymer 3 (manufactured by Kuraray Co., Ltd.; Exceval AQ-4104, degree of saponification: 98.0 mol % to 99.0 mol %, degree of polymerization: 400, ethylene copolymerization ratio: 0.059)
Vinyl alcohol copolymer 4 (manufactured by Kuraray Co., Ltd.; Exceval HR-3010, degree of saponification: 99.0 mol % to 99.4 mol %, degree of polymerization: 1,000, ethylene copolymerization ratio: 0.045)
Glutaraldehyde (manufactured by FUJIFILM Wako Pure Chemical Corporation)
Isopropanol (manufactured by FUJIFILM Wako Pure Chemical Corporation)
Hydrochloric acid (manufactured by FUJIFILM Wako Pure Chemical Corporation)

### Comparative Example 1

15 mass % of PSf and 85 mass % of DMF were dissolved at 100° C. to prepare a porous support layer raw liquid. This porous support layer raw liquid was applied to a surface of a polyester filament nonwoven fabric at 25° C., and after 3 seconds, the nonwoven fabric was immersed in a coagulation bath composed of distilled water at 25° C. for 30 seconds to coagulate, and washed with hot water at 80° C. for 2 minutes to obtain a support membrane in which a porous support layer composed of PSf was formed on the surface of the polyester filament nonwoven fabric as a substrate. A thickness of the porous support layer in the obtained support membrane was 30 μm.

Next, the obtained support membrane was immersed in a 3 mass % aqueous solution of m-PDA for 2 minutes, the support membrane was slowly pulled up in the vertical direction, and nitrogen was blown from an air nozzle to remove the excess aqueous solution from a surface of the support membrane. In an environment controlled to 25° C., 20 ml of a n-decane solution at 25° C. containing 0.12 mass % of TMC was applied such that the surface of the support membrane was completely wetted, and allowed to stand for 1 minute to form a separation functional layer by interfacial polymerization. Next, the obtained membrane was held vertically for 30 seconds, excess aqueous solution was removed by draining, and then the membrane was washed with hot water at 80° C. for 2 minutes. Further, the washed membrane was immersed in a 0.3 mass % aqueous solution of sodium nitrite at 35° C. and pH 3 for 1 minute, and then immersed in a 0.1 mass % sodium sulfite aqueous solution for 2 minutes to obtain a composite semipermeable membrane.

### Comparative Example 2

The composite semipermeable membrane obtained in Comparative Example 1 was immersed in an aqueous solution containing 0.01 mass % of PAA and 0.1 mass % of DMT-MM for 6 hours in an environment controlled at 20° C. to form a coating layer on the separation functional layer. Thereafter, the composite semipermeable membrane was made vertical, excess aqueous solution was removed by draining, and the membrane was washed with water at 40° C. for 2 minutes.

### Comparative Example 3

A solution (isopropanol/water=3/7) containing 0.25 mass % of PVA 1 (degree of saponification: 99.5 mol %, degree of polymerization: 2,600) was brought into contact with the entire surface of the separation functional layer of the composite semipermeable membrane obtained in Comparative Example 1 in an environment controlled at 20° C. In a state where the aqueous solution remained on the surface of the separation functional layer, the separation functional layer was held at 100° C. for 5 minutes, and the solution was brought into contact with the surface of the separation functional layer again and maintained at 130° C. for 5 minutes to form a coating layer on the separation functional layer. Thereafter, the separation functional layer was washed with water at 20° C. for 2 minutes. Finally, the composite semipermeable membrane was immersed in a 14 mass % aqueous solution of isopropanol at 20° C. for 5 minutes and subjected to hydrophilization treatment.

### Comparative Example 4

An aqueous solution containing 2.0 mass % of PVA 3 (degree of saponification: 87.0 mol % to 89.0 mol %, degree of polymerization: 900), 0.5 mass % of glutaraldehyde, and 0.1 mass % of sulfuric acid was brought into contact with the entire surface of the separation functional layer of the composite semipermeable membrane obtained in Comparative Example 1 in an environment controlled at 20° C. A coating layer was formed on the separation functional layer by blowing hot air at 70° C. to the composite semipermeable membrane for 3 minutes in a state where the aqueous solution remained on the surface of the separation functional layer. Thereafter, the composite semipermeable membrane was made vertical, an excess aqueous solution was removed by draining, and the membrane was washed with water at 20° C. for 2 minutes. Finally, the composite semipermeable membrane was immersed in a 14 mass % aqueous solution of isopropanol at 20° C. for 5 minutes to be subjected to hydrophilization treatment.

### Comparative Example 5

A coating layer was formed on a separation functional layer and subjected to hydrophilization treatment in the same manner as in Comparative Example 4 except that an aqueous solution containing 2.0 mass % of PVA 2 (degree of saponification: 98.0 mol % to 99.0 mol %, degree of polymerization: 900), 0.5 mass % of glutaraldehyde, and 0.1 mass % of sulfuric acid was used.

### Example 1

A coating layer was formed on a separation functional layer and subjected to hydrophilization treatment in the same manner as in Example 4 except that an aqueous solution containing 0.5 mass % of a vinyl alcohol copolymer 3 (Exceval AQ-4104), 0.3 mass % of glutaraldehyde, and 0.1 mass % of sulfuric acid was used, and the time for blowing hot air at 70° C. was set to 1 minute.

### Example 2

A coating layer was formed on a separation functional layer and subjected to hydrophilization treatment in the same manner as in Example 1 except that an aqueous solution containing 0.8 mass % of the vinyl alcohol copolymer 4 (Exceval HR-3010), 0.4 mass % of glutaraldehyde, and 0.1 mass % of sulfuric acid was used.

### Example 3

A coating layer was formed on a separation functional layer and subjected to hydrophilization treatment in the same manner as in Example 1 except that an aqueous solution containing 0.35 mass % of the vinyl alcohol copolymer 1 (Exceval RS-2117), 0.15 mass % of glutaraldehyde, and 0.1 mass % of sulfuric acid was used.

### Example 4

A coating layer was formed on a separation functional layer and subjected to hydrophilization treatment in the same manner as in Example 1 except that an aqueous solution containing 0.4 mass % of the vinyl alcohol copolymer 2 (Exceval RS-1717), 0.2 mass % of glutaraldehyde, and 0.1 mass % of sulfuric acid was used.

### Example 5

A coating layer was formed on a separation functional layer and subjected to hydrophilization treatment in the same manner as in Example 1 except that an aqueous solution containing 0.7 mass % of PVA 2 (degree of saponification: 98.0 mol % to 99.0 mol %, degree of polymerization: 900), 0.3 mol % of the vinyl alcohol copolymer 4 (Exceval HR-3010), 0.4 mass % of glutaraldehyde, and 0.1 mass % of sulfuric acid was used.

### Example 6

An aqueous solution containing 0.3 mass % of vinyl alcohol copolymer 4 (Exceval HR-3010), 0.2 mass % of glutaraldehyde, and 0.1 mass % of sulfuric acid was brought into contact with the entire surface of the separation functional layer of the composite semipermeable membrane obtained in Comparative Example 2 in an environment controlled at 20° C. A coating layer was formed on the separation functional layer by blowing hot air at 70° C. to the composite semipermeable membrane for 3 minutes while the aqueous solution remained on the surface of the separation functional layer. Thereafter, the composite semipermeable membrane was made vertical, an excess aqueous solution was removed by draining, and the membrane was washed with water at 20° C. for 2 minutes. Finally, the composite semipermeable membrane was immersed in a 14 mass % aqueous solution of isopropanol at 20° C. for 5 minutes to be subjected to hydrophilization treatment.

### Example 7

An aqueous solution containing 0.4 mass % of vinyl alcohol copolymer 4 (Exceval HR-3010), 0.2 mass % of glutaraldehyde, and 0.04 mol/l of hydrochloric acid was brought into contact with the entire surface of the separation functional layer of the composite semipermeable membrane obtained in Comparative Example 1 in an environment controlled at 20° C. In a state where the aqueous solution remained on the surface of the separation functional layer, the separation functional layer was held at 100° C. for 5 minutes, and the solution was brought into contact with the entire surface of the separation functional layer again and held at 130° C. for 5 minutes to form a coating layer on the separation functional layer. Thereafter, the separation functional layer was washed with water at 20° C. for 2 minutes. Finally, the composite semipermeable membrane was immersed in a 14 mass % aqueous solution of isopropanol at 20° C. for 5 minutes to be subjected to hydrophilization treatment.

Structures of the composite semipermeable membranes obtained in Comparative Examples 1 to 5 and Examples 1 to 7 are shown in Table 1, and the performances thereof are shown in Table 2 and Table 3. Since the membrane obtained in Comparative Example 1 had no coating layer, the adhesive strength was not measured.

TABLE 1

| | Membrane structure | | | | | | |
|---|---|---|---|---|---|---|---|
| | | | | | Total thickness T | | |
| | | | | | of separation | Root mean | |
| | | Copolymerization | Degree of | Degree of | functional layer | square | Adhesive |
| | Coating layer | ratio | polymerization | saponification | and coating layer | height Sq | strength |
| | — | — | — | mol % | nm | nm | N/25 mm |
| Comp. | — | — | — | — | 13 | 157 | — |
| Ex. 1 | | | | | | | |
| Comp. | PAA | — | — | — | 14 | 175 | 0.8 |
| Ex. 2 | | | | | | | |
| Comp. | PVA | — | 2600 | 99.5 | 122 | 86 | 0.6 |
| Ex. 3 | | | | | | | |
| Comp. | PVA | — | 900 | 87.0 to 89.0 | 13 | 149 | 0.1 |
| Ex. 4 | | | | | | | |
| Comp. | PVA | — | 900 | 98.0 to 99.0 | 14 | 144 | 0.2 |
| Ex. 5 | | | | | | | |
| Ex. 1 | Vinyl alcohol | 0.059 | 400 | 98.0 to 99.0 | 14 | 159 | 0.7 |
| | copolymer | | | | | | |
| Ex. 2 | Vinyl alcohol | 0.045 | 1000 | 99.0 to 99.4 | 14 | 156 | 2.5 |
| | copolymer | | | | | | |
| Ex. 3 | Vinyl alcohol | 0.030 | 1700 | 97.5 to 99.0 | 14 | 158 | 0.4 |
| | copolymer | | | | | | |
| Ex. 4 | Vinyl alcohol | 0.028 | 1700 | 92.0 to 94.0 | 13 | 147 | 0.2 |
| | copolymer | | | | | | |
| Ex. 5 | PVA | — | 900 | 98.0 to 99.0 | 14 | 156 | 2.2 |
| | Vinyl alcohol | 0.045 | 1000 | 99.0 to 99.4 | | | |
| | copolymer | | | | | | |
| Ex. 6 | PAA | — | — | — | 15 | 173 | 1.7 |
| | Vinyl alcohol | 0.045 | 1000 | 99.0 to 99.4 | | | |
| | copolymer | | | | | | |
| Ex. 7 | Vinyl alcohol | 0.045 | 1000 | 99.0 to 99.4 | 83 | 102 | 2.4 |
| | copolymer | | | | | | |

TABLE 2

| | NaCl | Water | | Water | | Water | |
|---|---|---|---|---|---|---|---|
| | removal | permeability | Helium | permeability/helium | He/O₂ | permeability F₁ | |
| | rate | F₀ | permeability | permeability | selectivity | after fouling | F₁/F₀ |
| | % | m/d/Mpa | m/d/Mpa | — | — | m/d/Mpa | — |
| Comp. | 99.76 | 1.03 | 153.7 | 0.0067 | 6.0 | 0.55 | 0.53 |
| Ex. 1 | | | | | | | |
| Comp. | 99.71 | 1.01 | 142.3 | 0.0071 | 6.2 | 0.88 | 0.87 |
| Ex. 2 | | | | | | | |
| Comp. | 99.69 | 0.68 | 73.1 | 0.0093 | 8.4 | 0.48 | 0.71 |
| Ex. 3 | | | | | | | |
| Comp. | 99.79 | 0.87 | 91.6 | 0.0095 | 7.8 | 0.69 | 0.79 |
| Ex. 4 | | | | | | | |
| Comp. | 99.78 | 0.90 | 88.2 | 0.0102 | 8.7 | 0.70 | 0.78 |
| Ex. 5 | | | | | | | |
| Ex. 1 | 99.81 | 0.89 | 81.7 | 0.0109 | 8.3 | 0.72 | 0.81 |
| Ex. 2 | 99.82 | 0.83 | 63.8 | 0.0130 | 9.9 | 0.66 | 0.80 |
| Ex. 3 | 99.79 | 0.90 | 84.9 | 0.0106 | 7.7 | 0.70 | 0.78 |
| Ex. 4 | 99.80 | 0.86 | 84.3 | 0.0102 | 7.9 | 0.68 | 0.79 |
| Ex. 5 | 99.79 | 0.82 | 65.6 | 0.0125 | 9.2 | 0.67 | 0.82 |
| Ex. 6 | 99.70 | 0.77 | 68.1 | 0.0113 | 7.6 | 0.66 | 0.86 |
| Ex. 7 | 99.67 | 0.69 | 42.9 | 0.0161 | 7.8 | 0.51 | 0.74 |

TABLE 3

| | NaCl removal rate | | | | | | |
|---|---|---|---|---|---|---|---|
| | | | | After contact | After | | |
| | | After | After | with | contact with | After contact with | After contact with alkali ⇒ |
| | Before | contact | contact | oxidizing | alkali → | alkali ⇒ acid ⇒ | acid ⇒ oxidizing agent ⇒ |
| | contact | with alkali | with acid | agent | acid | oxidizing agent | alkali ⇒ acid |
| | % | % | % | % | % | % | % |
| Comp. Ex. 1 | 99.76 | 99.59 | 99.67 | 99.74 | 99.55 | 99.50 | 98.98 |
| Comp. Ex. 2 | 99.71 | 99.46 | 99.66 | 99.65 | 99.43 | 99.37 | 98.73 |
| Comp. Ex. 3 | 99.69 | 99.55 | 99.61 | 99.67 | 99.46 | 99.42 | 98.91 |
| Comp. Ex. 4 | 99.79 | 99.64 | 99.70 | 99.78 | 99.58 | 99.58 | 99.06 |
| Comp. Ex. 5 | 99.78 | 99.62 | 99.69 | 99.78 | 99.55 | 99.56 | 99.12 |
| Ex. 1 | 99.81 | 99.70 | 99.76 | 99.82 | 99.68 | 99.75 | 99.44 |
| Ex. 2 | 99.82 | 99.72 | 99.76 | 99.83 | 99.69 | 99.76 | 99.53 |
| Ex. 3 | 99.79 | 99.66 | 99.71 | 99.79 | 99.61 | 99.64 | 99.26 |
| Ex. 4 | 99.80 | 99.65 | 99.70 | 99.79 | 99.58 | 99.60 | 99.19 |
| Ex. 5 | 99.79 | 99.68 | 99.72 | 99.80 | 99.63 | 99.65 | 99.31 |
| Ex. 6 | 99.70 | 99.45 | 99.66 | 99.68 | 99.42 | 99.47 | 99.15 |
| Ex. 7 | 99.67 | 99.50 | 99.63 | 99.66 | 99.47 | 99.51 | 99.24 |

As shown in Table 3, the composite semipermeable membrane including the coating layer containing the vinyl alcohol copolymer in Examples 1 to 7 had high chemical resistance and exhibited sufficient water permeability after fouling.

From the results in Examples 1 to 4, it was found that the higher the copolymerization ratio of ethylene in the vinyl alcohol copolymer, the better the membrane performance of the composite semipermeable membrane after the membrane deterioration test. Further, it was found from the comparison between Examples 3 and 4 that the membrane performance of the composite semipermeable membrane after the membrane deterioration test was improved by increasing the degree of saponification of the vinyl alcohol copolymer.

Although the present invention has been described in detail with reference to specific embodiments, it is apparent to those skilled in the art that various changes and modifications can be made without departing from the spirit and scope of the present invention. The present application is based on Japanese Patent Applications No. 2023-015302, No. 2023-015303, and No. 2023-015304 filed on Feb. 3, 2023, the contents of which are incorporated herein by reference.

### REFERENCE SIGNS LIST

1 composite semipermeable membrane
2 support membrane
3 separation functional layer
4 coating layer
5 protrusion interior

1. A composite semipermeable membrane comprising:
a support membrane;
a separation functional layer disposed on the support membrane and containing a crosslinked polyamide; and
a coating layer disposed on the separation functional layer and containing a vinyl alcohol copolymer having a structure represented by the following general formula (1), 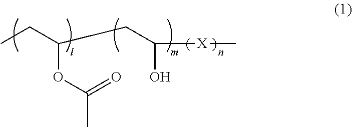
provided that in the general formula (1), X is a divalent hydrocarbon group having 2 to 6 carbon atoms, and l, m and n are the number of repeating units.

2. The composite semipermeable membrane according to claim 1, wherein
X in the general formula (1) is a divalent hydrocarbon group having 2 carbon atoms.

3. The composite semipermeable membrane according to claim 2, wherein
X in the general formula (1) is an ethylene group.

4. The composite semipermeable membrane according to claim 1, wherein
the vinyl alcohol copolymer has a copolymerization ratio n/(l+m+n) of 0.035 to 0.16.

5. The composite semipermeable membrane according to claim 1, wherein
the vinyl alcohol copolymer has a degree of polymerization of 100 to 1,500.

6. The composite semipermeable membrane according to claim 1, wherein
the vinyl alcohol copolymer has a degree of saponification of 96 mol % or more.

7. The composite semipermeable membrane according to claim 1, wherein
a total thickness of the separation functional layer and the coating layer is 10 nm to 100 nm.

8. The composite semipermeable membrane according to claim 1, wherein
the composite semipermeable membrane has a ratio of water permeability to helium permeability of 0.0105 to 0.0400.

9. The composite semipermeable membrane according to claim 1, wherein
the composite semipermeable membrane has a He/02 selectivity of 7.5 to 10.4.

10. The composite semipermeable membrane according to claim 1, wherein
an adhesive strength when the coating layers of the two composite semipermeable membranes are attached to each other is 0.9 N/25 mm to 5.0 N/25 mm.

11. A composite semipermeable membrane module comprising the composite semipermeable membrane according to claim 1.

12. A fluid separation device comprising the composite semipermeable membrane module according to claim 11.

13. A method for producing the composite semipermeable membrane according to claim 1, the method comprising the following steps (i) and (ii):
(i) a step of subjecting a polyfunctional amine and a polyfunctional acid chloride to interfacial polymerization on a support membrane to form a separation functional layer containing a crosslinked polyamide; and
(ii) a step of forming a coating layer containing a vinyl alcohol copolymer represented by the following general formula (1), by bringing a solution containing the vinyl alcohol copolymer into contact with the separation functional layer and insolubilizing the vinyl alcohol copolymer, 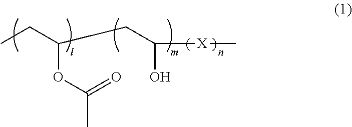
provided that in the general formula (1), X is a divalent hydrocarbon group having 2 to 6 carbon atoms, and l, m and n are the number of repeating units.
